(19) United States
(12) Patent Application Publication
(10) Pub. No.: US 2025/0341648 A1
(43) Pub. Date: Nov. 6, 2025

(54) METHOD FOR EXTRACTING SURFACE WAVE DISPERSION CURVES BASED ON STRAIN FIELDS

(71) Applicant: SOUTHERN UNIVERSITY OF SCIENCE AND TECHNOLOGY, Shenzhen (CN)

(72) Inventors: Shichuan YUAN, Shenzhen (CN); Xiaofei CHEN, Shenzhen (CN); Hengxin REN, Shenzhen (CN); Jiannan WANG, Shenzhen (CN); Haoran MENG, Shenzhen (CN)

(73) Assignee: SOUTHERN UNIVERSITY OF SCIENCE AND TECHNOLOGY, Shenzhen (CN)

(21) Appl. No.: 19/021,515

(22) Filed: Jan. 15, 2025

(30) Foreign Application Priority Data
May 6, 2024 (CN) 202410547428.1

(51) Int. Cl. G01V 1/30; G01V 1/22; G01V 1/34

(52) U.S. Cl. CPC G01V 1/303; G01V 1/226; G01V 1/345

(57) ABSTRACT

A method for extracting surface wave dispersion curves based on strain fields is provided. The method includes: extracting strain data from seismic observation data; pre-processing the strain data according to types of the seismic observation data to obtain strain components; transforming the strain components from Temporal-Spatial Domain to Spatial-Frequency Domain by Fourier Transform; transforming the strain components from the Spatial-Frequency Domain to Frequency-Phase Velocity Domain by Frequency-Bessel Transform to obtain a surface wave dispersion spectrum of the strain components; picking surface wave dispersion curves according to the surface wave dispersion spectrum. The embodiments fill the gap in extracting surface wave dispersion information from DAS data, and provide a powerful tool for extracting surface wave dispersion information suitable for single-component or multi-component DAS data, which has important theoretical significance and practical value for the development of surface wave dispersion imaging methods based on DAS observations.

### CROSS-REFERENCE TO RELATED APPLICATIONS

This application claims priority to Chinese Patent Application No. 202410547428.1, filed on May 6, 2024, the content of all of which is incorporated herein by reference.

### FIELD

The present disclosure relates to the technical field of surface wave dispersion imaging, in particular to a method for extracting surface wave dispersion curves based on strain fields.

### BACKGROUND

Surface wave dispersion imaging can be applied to detect the shear wave velocity structure of underground media by extracting and inverting surface wave dispersion curves. Surface wave dispersion imaging is one of the important methods of seismic imaging and has been widely used in the imaging of the Earth's internal structure at shallow surface, regional and global scales.

Distributed acoustic sensing (DAS) technology, also referred to as Distributed Fiber Optic Vibration Sensing Technology in the field of seismology, is a new type of dense array observation technology that has developed rapidly in recent years. The DAS technology has the advantages of low observation cost, wide application range, and strong repeatability. The DAS technology has been rapidly applied in seismological research in different scenarios and scales. The DAS technology is very suitable for imaging of shallow surface structures on land and undersea. Compared with traditional seismic observation instruments of observing data on seismic displacement (or velocity) fields, the DAS technology observes a response of seismic strain (or strain rate) fields along an axial direction of the optical fiber.

At present, there is no clear theoretical understanding of how to accurately extract surface wave dispersion curves from DAS data. The Frequency-Bessel transformation method has been proven to be more effective in extracting multi-mode surface wave dispersion curves from array seismic data of traditional seismic observations. However, there is currently no theoretical method for extracting surface wave dispersion curves from single-component or multi-component DAS data from the perspective of seismic strain (or strain rate) fields.

In sum, from the perspective of strain fields, there is currently a technical gap in the method for extracting surface wave dispersion curves from DAS data, which needs to be further improved.

### SUMMARY

In view of the above-mentioned deficiencies in the prior art, the present disclosure provides a method for extracting surface wave dispersion curves based on strain fields. Based on strain fields from a perspective of seismic strain fields by using Bessel functions, the method solves the problem of the lack of methods for extracting surface wave dispersion curves in the prior art.

In a first aspect, the present disclosure provides a method for extracting surface wave dispersion curves based on strain fields. The method includes:
Extracting strain data from seismic observation data;
Pre-processing the strain data according to types of the seismic observation data to obtain strain components;
Transforming the strain components from Temporal-Spatial Domain to Spatial-Frequency Domain by Fourier Transform;
Transforming the strain components from the Spatial-Frequency Domain to Frequency-Phase Velocity Domain by Frequency-Bessel Transform to obtain a surface wave dispersion spectrum of the strain components;
Picking surface wave dispersion curves according to the surface wave dispersion spectrum.

Specifically, the seismic observation data is single-component or multi-component DAS strain observation data; the types of the seismic observation data comprise one or more of active source data with known sources, active source data with unknown sources, and passive source data.

Specifically, the step of pre-processing the strain data according to types of the seismic observation data to obtain strain components includes:
For the strain data extracted from the active source data with known sources, transforming the strain data into Green's function components by deconvolution processing, wherein the strain components are the Green's function components;
For the strain data extracted from the active source data with unknown sources, directly using the strain data extracted from the active source data with unknown source as the strain components;
For the strain data extracted from the passive source data, transforming the strain data into empirical Green's function components, and the strain components are the empirical Green's function components.

Specifically, the transforming the strain data into empirical Green's function components comprises:
Performing background noise processing on the strain data to restore the empirical Green's function components;
Where the background noise processing comprises single-channel pre-processing, two-channel cross-correlation processing, and superposition processing of noise cross-correlation functions in different time periods;
Where the single-channel pre-processing comprises: removing instrument response processing, data segmentation processing, removing mean processing, detrending processing, bandpass filtering processing, time domain normalization processing, and spectrum whitening processing.

Specifically, the strain data includes one or more of radial normal strain, radial shear strain, tangential normal strain, and vertical normal strain.

Specifically, after the extracting strain data from seismic observation data, the method further includes:
Synthesizing strain field records based on multiple channels of the strain data;
Specifically, the strain field records include radial normal strain records from vertical excitation, vertical normal strain records from vertical excitation, tangential normal strain records from vertical excitation, radial normal strain records from radial excitation, vertical normal strain records from radial excitation, tangential normal strain records from radial excitation, and radial shear strain records from tangential excitation.

Specifically, the picking surface wave dispersion curves according to the surface wave dispersion spectrum includes:
Identifying dispersion energy of the strain components from actual dispersion spectrum;
Determining a frequency and a corresponding phase velocity value of the surface wave based on a position of an extreme value in the dispersion energy in the Frequency-Phase Velocity Domain;
Picking the surface wave dispersion curves of the strain components based on a plurality of sets of the frequencies and the corresponding phase velocity values.

Specifically, the surface wave dispersion curves include Rayleigh wave dispersion curves and Love wave dispersion curves.

A second aspect of the present disclosure provides a system for extracting surface wave dispersion curves based on strain fields, the system includes:
A data extraction module, configured to extract strain data from seismic observation data;
A pre-processing module, configured to pre-process the strain data according to types of the seismic observation data to obtain strain components;
A time-frequency transformation module, configured to transform the strain components from Temporal-Spatial Domain to Spatial-Frequency Domain by Fourier Transform;
A Bessel transformation module, configured to transform the strain components from the Spatial-Frequency Domain to Frequency-Phase Velocity Domain through Frequency-Bessel Transform to obtain the surface wave dispersion spectrum of the strain component;
A picking module, configured to pick surface wave dispersion curves according to the surface wave dispersion spectrum.

A third aspect of the present disclosure provides a terminal, including: a memory, a processor, and a program for extracting surface wave dispersion curves based on strain fields stored in the memory and executed by the processor; when the program is executed by the processor, steps of the method for extracting surface wave dispersion curves based on strain fields are implemented.

Compared with the existing methods, the method for extracting surface wave dispersion curves based on strain fields of the present disclosure has beneficial effects as follows: the present disclosure provides a method for extracting surface wave dispersion curves based on strain fields, including the steps of: extracting strain data from seismic observation data; pre-processing the strain data according to types of the seismic observation data to obtain strain components; transforming the strain components from Temporal-Spatial Domain to Spatial-Frequency Domain by Fourier Transform; transforming the strain components from the Spatial-Frequency Domain to Frequency-Phase Velocity Domain by Frequency-Bessel Transform to obtain a surface wave dispersion spectrum of the strain components; picking surface wave dispersion curves according to the surface wave dispersion spectrum. For single-component or multi-component DAS data and from the perspective of strain fields, the present disclosure proposes different Frequency-Bessel transform formulas for active source data with known seismic sources, active source data with unknown seismic sources, and passive source data, respectively, to extract surface wave dispersion spectrum, and then pick surface wave dispersion curves, filling the technical gap in extracting surface wave dispersion information from DAS data, and providing a powerful tool for extracting surface wave dispersion information suitable for single-component or multi-component DAS data. It has important theoretical significance and practical value for the development of surface wave dispersion imaging methods based on DAS observations, and provides ideas for extracting dispersion information of surface waves or body waves such as Rayleigh waves, Scholte waves, and Love waves.

### BRIEF DESCRIPTION OF THE DRAWINGS

In order to more clearly illustrate the embodiments of the present disclosure or the technical schemes in the prior art, the drawings required for use in the embodiments or the description of the prior art are briefly introduced below. Obviously, the drawings described below are only some embodiments recorded in the present disclosure. For those skilled in the art, other drawings can be obtained based on these drawings without involving creative work.

FIG. 1 is a schematic flow chart of a method for extracting surface wave dispersion curves based on strain fields in one embodiment.

FIG. 2 is a schematic diagram of synthetic records of strain fields of different strain components in one embodiment.

FIG. 3 is a schematic diagram of a plurality of theoretical surface wave dispersion spectrum from different strain components in one embodiment.

FIG. 4 is a schematic diagram of a plurality of actual surface wave dispersion spectrum from the different strain components in one embodiment.

FIG. 5 is a schematic diagram of a plurality of approximated actual surface wave dispersion spectrum from the different strain components in one embodiment.

FIG. 6 is a schematic diagram of a system for extracting surface wave dispersion curves based on strain fields in one embodiment.

### DETAILED DESCRIPTION OF EMBODIMENTS

In order to enable those skilled in the art to better understand the schemes of the present disclosure, the technical schemes in the embodiments of the present disclosure are clearly and completely described below in combination with the attached drawings in the embodiments of the present disclosure. Obviously, the described embodiments are only part of the embodiments of the present disclosure, not all of the embodiments. Based on the embodiments of the present disclosure, all other embodiments obtained by those skilled in the art without creative work are within the scope of protection of the present disclosure.

It should be understood that the terms used here in the specification of the embodiments of the present disclosure are solely for the purpose of describing specific embodiments and are not intended to limit the embodiments of the present disclosure. As used in the embodiment of the present disclosure and the attached claims, the terms “one”, “a”, “an”, and “the” are intended to include the plural form unless the context clearly indicates otherwise.

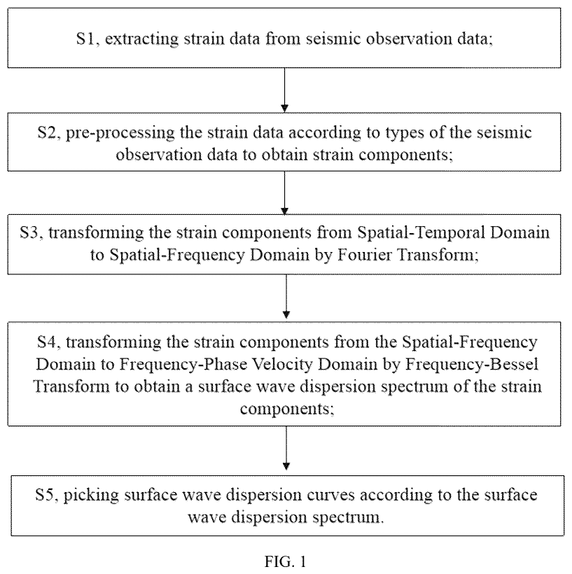

The present disclosure provides a method for extracting surface wave dispersion curves based on strain fields. As shown in FIG. 1, a schematic flow chart of the method for extracting surface wave dispersion curves based on strain fields of the present disclosure is illustrated. The method includes the following steps:

S1, extracting strain data from seismic observation data.

Specifically, the strain data includes one or more of radial normal strain, radial shear strain, tangential normal strain, and vertical normal strain.

Specifically, after step S1, the method further includes: synthesizing strain field records based on multiple channels of the strain data.

Specifically, the strain field records include radial normal strain records from vertical excitation, vertical normal strain records from vertical excitation, tangential normal strain records from vertical excitation, radial normal strain records from radial excitation, vertical normal strain records from radial excitation, tangential normal strain records from radial excitation, and radial shear strain records from tangential excitation. In the present disclosure, the seismic observation data is single-component or multi-component strain observation data based on Distributed Acoustic Sensing (DAS). Distributed Acoustic Sensing (DAS) technology is also referred to as Distributed Fiber Optic Vibration Sensing Technology in the field of seismology. In practical applications, optical cables are usually laid horizontally during ground observations, and vertically during well observations. Multi-component observations can also be achieved by laying methods such as spiral winding of optical cables. The optical cables are usually provided with multiple observation channels with a certain spacing to obtain multiple seismic observation data, and multiple strain field records can be generated in different strain directions. Preferably, the strain field records include 150 channels, and a channel spacing is 2 m.

In the present disclosure, strain observation directions include normal direction, tangential direction, and vertical direction. Therefore, the strain data includes one or more of radial normal strain εᵣᵣ, radial tangential strain Ere, tangential normal strain ε_{θθ}, and vertical normal strain ε_{zz}, where r, θ, and z represent coordinate variables (i.e., radius, azimuth, and depth) in radial, tangential and vertical directions, respectively.

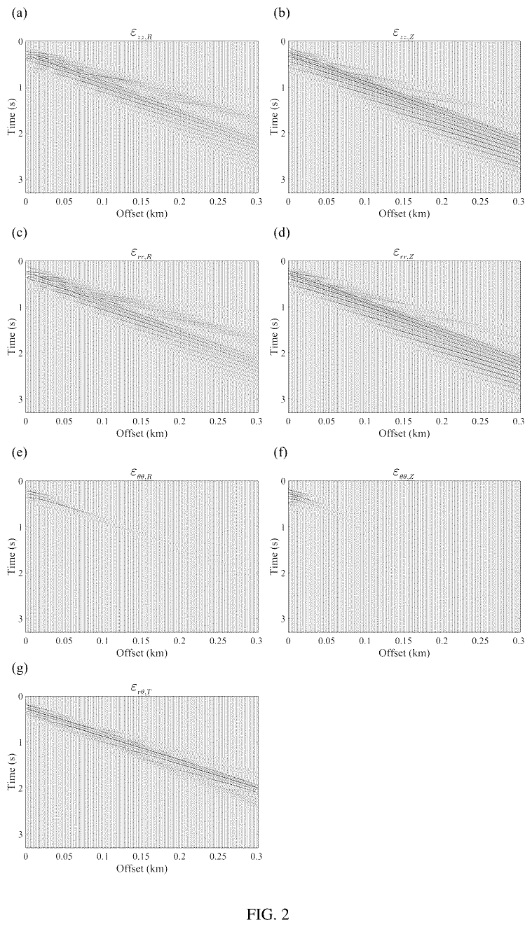

As shown in FIG. 2, which is a schematic diagram of synthetic records of strain fields of different strain components in one embodiment. The strain field records include 150 channels with a trace spacing of 2 m. In each figure of FIG. 2, a horizontal axis is the offset and a vertical axis is the time. FIG. 2 shows the synthetic records of the strain data of different components in the Temporal-Spatial Domain. FIG. 2(a) is the vertical normal strain records from radial excitation ε_{zz,R}; FIG. 2(b) is the vertical normal strain records from vertical excitation ε_{zz,Z}; FIG. 2(c) is the radial normal strain records from radial excitation ε_{rr,R}; FIG. 2 (d) is the radial normal strain records from vertical excitation ε_{rr,Z}; FIG. 2 (e) is the tangential normal strain records from radial excitation ε_{θθ,R}; FIG. 2 (f) is the tangential normal strain records from vertical excitation ε_{θθ,Z}; FIG. 2 (g) is the radial shear strain records from tangential excitation ε_{rθ,T}; the subscripts R, T, and Z represent the vertical, tangential, and radial excitation directions of the seismic source, respectively.

The present disclosure provides a method for extracting surface wave dispersion curves based on strain fields, further including: S2, pre-processing the strain data according to types of the seismic observation data to obtain strain components.

Specifically, the seismic observation data is single-component or multi-component strain observation data based on DAS technology; the types of the seismic observation data include one or more of active source data with known sources, active source data with unknown sources, and passive source data. In some embodiments, the passive source data is background noise data.

Specifically, step S2 includes the following steps:
S21, for the strain data extracted from the active source data with known sources, transforming the strain data into Green's function components by deconvolution processing, wherein the strain components are the Green's function components;
Or S22, for the strain data extracted from the active source data with unknown sources, directly using the strain data extracted from the active source data with unknown source as the strain components;
Or S23, for the strain data extracted from the passive source data, transforming the strain data into empirical Green's function components, and the strain components are the empirical Green's function components.

Due to the different data types, the subsequent Frequency-Bessel transformation processing is also different. Before the Fourier Transform, the strain data is processed according to different data sources.

The present disclosure provides a method for extracting surface wave dispersion curves based on strain fields, further including: S3, transforming the strain components from the Temporal-Spatial Domain to the Spatial-Frequency Domain by Fourier Transform.

Specifically, the formula used in the Fourier transform is

$$F ( ω ) = {\int }_{- ∞}^{+ ∞} f ( t ) exp ( - i ω t ) dt ,$$

where t represents the time variable, f(t) represents the time domain data, F(ω) represents the spectrum corresponding to f(t), and ω represents the angular frequency. Fourier transform can also be expressed as F(ω)=FFT[f(t)], where FFT[⋅] represents the Fourier transform function.

Specifically, the passive source data needs to be processed for background noise to restore an empirical Green's function. Therefore, the step of for the strain data extracted from the passive source data, transforming the strain data into empirical Green's function components, also includes the following steps:

Performing background noise processing on the strain data to restore the empirical Green's function components.

Specifically, the background noise processing includes one or more of single-channel pre-processing, two-channel cross-correlation processing, and superposition processing of noise cross-correlation functions in different time periods.

Specifically, the single-channel pre-processing includes: removing instrument response processing, data segmentation processing, removing mean processing, detrending processing, bandpass filtering processing, time domain normalization processing, and spectrum whitening processing.

The present disclosure provides a method for extracting surface wave dispersion curves based on strain fields, further including: S4, transforming the strain components from the Spatial-Frequency Domain to the Frequency-Phase Velocity Domain by Frequency-Bessel Transform to obtain a surface wave dispersion spectrum of the strain components.

Since the Frequency-Phase Velocity Domain can be replaced by the Frequency-Wavenumber Domain, that is, a method for extracting surface wave dispersion curves based on strain fields in the present disclosure also includes the step of: transforming the strain components from the Spatial-Frequency Domain to the Frequency-Wavenumber Domain by Frequency-Bessel Transform to obtain a surface wave dispersion spectrum of the strain components.

Specifically, different Frequency-Bessel Transforms are configured to use different types of the seismic observation data, including active source data with known sources, active source data with unknown sources, and passive source data.

Specifically, the method of Frequency-Bessel Transform in the present disclosure is derived from the Cylindrical Coordinate System and Generalized Reflection-Transmission Coefficient Method.

First, based on a relationship between the strain fields and displacement fields and an expression of the displacement fields, the expressions of the four strain data (radial normal strain, radial shear strain, tangential normal strain, and vertical normal strain) in the Frequency Domain in the Cylindrical Coordinate System are established:

$$[ \begin{matrix}{ε}_{rr} ( r , θ , z , ω ) \\ {ε}_{θθ} ( r , θ , z , ω ) \\ {ε}_{r θ} ( r , θ , z , ω ) \\ {ε}_{zz} ( r , θ , z , ω )\end{matrix} ] = [ \text{} \begin{matrix}{G}_{rr , R} ( r , z , ω ) & 0 & {G}_{rr , Z} ( r , z , ω ) \\ {G}_{θθ , R} ( r , z , ω ) & 0 & {G}_{θθ , Z} ( r , z , ω ) \\ 0 & {G}_{r θ , T} ( r , z , ω ) & 0 \\ {G}_{zz , R} ( r , z , ω ) & 0 & {G}_{zz , Z} ( r , z , ω )\end{matrix} ] [ \begin{matrix}F ( ω ) {m}_{R} ( θ ) \\ F ( ω ) {m}_{T} ( θ ) \\ F ( ω ) {m}_{z}\end{matrix} ] , \qquad ( 1 )$$

where r, θ, and z represent coordinate variables (i.e., radius, azimuth, and depth) in radial, tangential and vertical directions, respectively; w represents the angular frequency; F(ω) represents the source-time function in the Frequency domain; the unit direction vector of a single force point source in the cylindrical coordinate system is expressed as m=(m_{R}(θ), m_{T}(θ),m_{Z}); the subscripts R, T, and Z represent the vertical, tangential, and radial excitation directions of the seismic source, respectively (R is radial, T is tangential, and Z is vertical); G_{ξ,ζ} represents the Green's functions of the strain fields in different excitation and receiving directions, where ξ=rr, θθ, rθ, zz, and ζ=R, T, Z. For example, G_{rr,Z} represents the Green's function of the radial normal strain from a vertical source.

Here, for different types of active source data with known seismic sources, active source data with unknown seismic sources, and passive source data, the above strain components are different. For the strain data extracted from the active source data with known sources, the strain data is converted into Green's function components by deconvolution processing, and the strain components are the Green's function components; for the strain data extracted from the active source data with unknown sources, directly using the strain data extracted from the active source data with unknown source as the strain components; for the strain data extracted from the passive source data, transforming the strain data into empirical Green's function components, and the strain components are the empirical Green's function components.

For the strain data extracted from the active source data with a known seismic source, a correlation relationship between the strain data and a corresponding Green's function component and a seismic source time function is established through the expression of the above formula (1).

By using the Generalized Reflection-Transmission Coefficient Method, the expressions of the strain fields Green's functions of different components in the above formula (1) can be obtained, as shown in the following formulas (2) to (8):

$${G}_{rr , R} ( r , z , ω ) = \frac{1}{2 π} {\int }_{0}^{+ ∞} ( ( {[ {g}_{PS , 1} ( k , z , ω ) ]}_{1} - {g}_{SH , 1} ( k , z , ω ) ) \frac{1}{r} {J}_{2} ( k r ) - {[ {g}_{PS , 1} ( k , z , ω ) ]}_{1} {kJ}_{1} ( k r ) ) kdk , \qquad ( 2 )$$

$${G}_{rr , Z} ( r , z , ω ) ) = \frac{1}{2 π} {\int }_{0}^{+ ∞} ( {[ {g}_{PS , 0} ( k , z , ω ) ]}_{1} ( \frac{1}{r} {J}_{1} ( k r ) - {kJ}_{0} ( k r ) ) ) kdk , \qquad ( 3 )$$

$${G}_{θ θ , R} ( r , θ , z , ω ) = \frac{1}{2 π} {\int }_{0}^{+ ∞} ( ( {g}_{SH , 1} ( k , z , ω ) - {[ {g}_{PS , 1} ( k , z , ω ) ]}_{1} ) \frac{1}{r} {J}_{2} ( k r ) ) kdk , \qquad ( 4 )$$

$${G}_{θθ , Z} ( r , θ , z , ω ) = \frac{1}{2 π} {\int }_{0}^{+ ∞} ( - {[ {g}_{PS , 0} ( k , z , ω ) ]}_{1} \frac{1}{r} {J}_{1} ( k r ) ) kdk , \qquad ( 5 )$$

$${G}_{r θ , T} ( r , θ , z , ω ) = \frac{1}{2 π} {\int }_{0}^{+ ∞} \{ ( {g}_{SH , 1} ( k , z , ω ) - {[ {g}_{PS , 1} ( k , z , ω ) ]}_{1} ) \frac{1}{r} {J}_{2} ( k r ) - \frac{1}{2} {g}_{SH , 1} ( k , z , ω ) {kJ}_{1} ( k r ) \} kdk , \qquad ( 6 )$$

$${G}_{z z , R} ( r , θ , z , ω ) = \frac{1}{2 π} {\int }_{0}^{+ ∞} ( - \frac{\partial {[ {g}_{PS , 1} ( k , z , ω ) ]}_{2}}{\partial z} {J}_{1} ( k r ) ) kdk , \qquad ( 7 )$$

$${G}_{zz , Z} ( r , θ , z , ω ) = \frac{1}{2 π} {\int }_{0}^{+ ∞} ( - \frac{\partial {[ {g}_{P S 0} ( k , z , ω ) ]}_{2}}{\partial z} {J}_{0} ( k r ) ) kdk , \qquad ( 8 )$$

where k represents the wavenumber, J₀ (kr) represents the zero-order first-kind Bessel function, J₁ (kr) represents the first-order first-kind Bessel function, J₂ (kr) represents the second-order first-kind Bessel function; [g_{PS,0}]₁ [g_{PS,0}]₂ [symbol] [g_{PS,1}]₁, [g_{PS,1}]₂ and g_{SH,1} are the integral kernels in the wavenumber integral of the Green's functions.

By using orthogonality of the Bessel functions and a combination of different Green's function components, the above formulas (2) to (8) are transformed to obtain the following formulas (9) to (13):

$${\int }_{0}^{+ ∞} [ {G}_{r r , R} ( r , z , ω ) + {G}_{θ θ , R} ( r , z , ω ) ] {J}_{1} ( k r ) r d r = - {\frac{1}{2 π} [ {g}_{P S , 1} ( k , z , ω ) ]}_{1} k , \qquad ( 9 )$$

$${\int }_{0}^{+ ∞} [ {G}_{rr , Z} ( r , z , ω ) + {G}_{θ θ , Z} ( r , z , ω ) ] {J}_{0} ( k r ) r d r = - {\frac{1}{2 π} [ {g}_{PS , 0} ( k , z , ω ) ]}_{1} k , \qquad ( 10 )$$

$${\int }_{0}^{+ ∞} [ {G}_{r θ , T} ( r , z , ω ) - {G}_{θ θ , R} ( r , z , ω ) ] {J}_{1} ( k r ) r d r = - \frac{1}{4 π} {g}_{SH , 1} ( k , z , ω ) k , \qquad ( 11 )$$

$${\int }_{0}^{+ ∞} {G}_{z z , R} ( r , z , ω ) {J}_{1} ( k r ) r d r = - \frac{1}{2 π} \frac{\partial {[ {g}_{PS , 1} ( k , z , ω ) ]}_{2}}{\partial z} , \qquad ( 12 )$$

$${\int }_{0}^{+ ∞} {G}_{zz , Z} ( r , z , ω ) {J}_{0} ( k r ) r d r = - \frac{1}{2 π} \frac{\partial {[ {g}_{PS , 0} ( k , z , ω ) ]}_{2}}{\partial z} . \qquad ( 13 )$$

An expression of the theoretical dispersion spectrum and a Frequency-Bessel transform formula of the actual dispersion spectrum are obtained by performing a transformation on the above formulas (9) to (13), the formulas (9) to (13) on both sides of the equal sign are transformed respectively.

Specifically, the imaginary parts of both sides of formulas (9) to (13) are taken (i.e., performing Im(⋅)), and the right-hand side formulas are defined as the theoretical dispersion spectrum S_{R01}, S_{R02}, S_{R11}, S_{R12}, and S_{L} of real values, that is:

$${S}_{R 01} ( k , z , ω ) = - \frac{1}{2 π} Im ( {[ {g}_{P S , 0} ( k , z , ω ) ]}_{1} k ) , \qquad ( 14 )$$

$${S}_{R 02} ( k , z , ω ) = - \frac{1}{2 π} Im ( \frac{\partial {[ {g}_{PS , 0} ( k , z , ω ) ]}_{2}}{\partial z} ) , \qquad ( 15 )$$

$${S}_{R 11} ( k , z , ω ) ) = - \frac{1}{2 π} Im ( {[ {g}_{P S , 1} ( k , z , ω ) ]}_{1} k ) , \qquad ( 16 )$$

$${S}_{R 12} ( k , z , ω ) = - \frac{1}{2 π} Im ( \frac{\partial {[ {g}_{PS , 1} ( k , z , ω ) ]}_{2}}{\partial z} ) , \qquad ( 17 )$$

$${S}_{L} ( k , z , ω ) = - \frac{1}{4 π} Im ( {g}_{S H , 1} ( k , z , ω ) k ) , \qquad ( 18 )$$

where the subscripts R and L represent Rayleigh wave and Love wave, respectively, and the subscripts 0, 1, and 2 are configured to distinguish different variables.

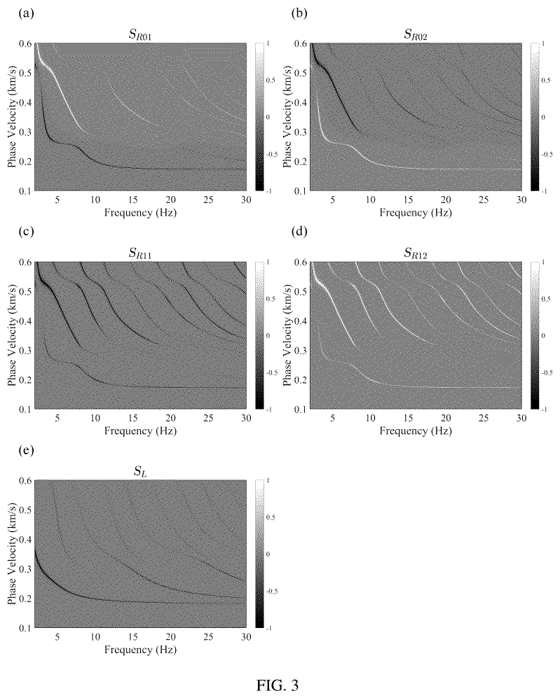

As shown in FIG. 3, which is a schematic diagram of a plurality of theoretical surface wave dispersion spectrum from different strain components in one embodiment. In each figure, the horizontal axis is the Frequency and the vertical axis is Phase Velocity. FIG. 3(a) is the theoretical dispersion spectrum S_{R01} of Rayleigh waves calculated by formula (14); FIG. 3(b) is the theoretical dispersion spectrum S_{R02} of Rayleigh waves calculated by formula (15); FIG. 3(c) is the theoretical dispersion spectrum S_{R11} of Rayleigh waves calculated by formula (16); FIG. 3(d) is the theoretical dispersion spectrum S_{R12} of Rayleigh waves calculated by formula (17); FIG. 3(e) is the theoretical dispersion spectrum S_{L} of Love waves calculated by formula (18).

Specifically, in actual calculations, the offset has a range limit. Within the radial offset range of [rₘᵢₙ, rₘₐₓ], for the active source data with known sources, the strain data is converted into Green's function components, and then the Green's function components are converted from the Temporal-Spatial Domain to the Spatial-Frequency Domain through Fourier transform, and then the Green's function components are converted from the Spatial-Frequency Domain to the Frequency-Wavenumber Domain or the Frequency-Phase Velocity Domain by Frequency-Bessel Transform to obtain the surface wave dispersion spectrum of the Green's function components. The left side of formulas (9) to (13) represent the actual dispersion spectrum D corresponding to the Green's function components G, which specifically includes D_{R01}, D_{R02}, D_{R11}, D_{R12}, and D_{L}, and are calculated using the following formulas:

$${D}_{R 01} ( k , z , ω ) = Im ( {\int }_{{r}_{min}}^{{r}_{max}} [ {G}_{rr , Z} ( r , z , ω ) + {G}_{θθ , Z} ( r , z , ω ) ] {J}_{0} ( k r ) rdr ) , \qquad ( 19 )$$

$${D}_{R 02} ( k , z , ω ) = Im ( {\int }_{{r}_{min}}^{{r}_{max}} {G}_{z z , Z} ( r , z , ω ) {J}_{0} ( k r ) r dr ) , \qquad ( 20 )$$

$${D}_{R 11} ( k , z , ω ) = Im ( {\int }_{{r}_{min}}^{{r}_{max}} [ {G}_{r r , R} ( r , z , ω ) + {G}_{θ θ , R} ( r , z , ω ) ] {J}_{1} ( k r ) r dr ) , \qquad ( 21 )$$

$${D}_{R 12} ( k , z , ω ) = Im ( {\int }_{{r}_{min}}^{{r}_{max}} {G}_{z z , R} ( r , z , ω ) {J}_{1} ( k r ) r dr ) , \qquad ( 22 )$$

$${D}_{L} ( k , z , ω ) = Im ( {\int }_{{r}_{min}}^{{r}_{max}} [ {G}_{r θ , T} ( r , z , ω ) - {G}_{θ θ , R} ( r , z , ω ) ] {J}_{1} ( k r ) r dr ) , \qquad ( 23 )$$

The formulas (19) to (23) are the precise Frequency-Bessel transform formulas corresponding to the Green's function. Since it can be seen from formulas (4) and (5) that G_{θθ,R} and G_{θθ,Z} reduce rapidly with the increase of offset r (including a factor 1/r), which have little contribution to the integral of formulas (19), (21) and (23). When G_{θθ,R} and G_{θθ,Z} are ignored, the approximate Frequency-Bessel transform formulas corresponding to formulas (19), (21) and (23) are:

$${D}_{aR 01} ( k , z , ω ) = Im ( {\int }_{{r}_{min}}^{{r}_{max}} {G}_{r r , Z} ( r , z , ω ) {J}_{0} ( k r ) rdr ) , \qquad ( 24 )$$

$${D}_{aR 11} ( k , z , ω ) = Im ( {\int }_{{r}_{min}}^{{r}_{max}} {G}_{r r , R} ( r , z , ω ) {J}_{1} ( k r ) r dr ) , \qquad ( 25 )$$

$${D}_{aL} ( k , z , ω ) ) = Im ( {\int }_{{r}_{min}}^{{r}_{max}} {G}_{r θ , T} ( r , z , ω ) {J}_{1} ( k r ) r dr ) , \qquad ( 26 )$$

where the subscript a represents the approximate value.

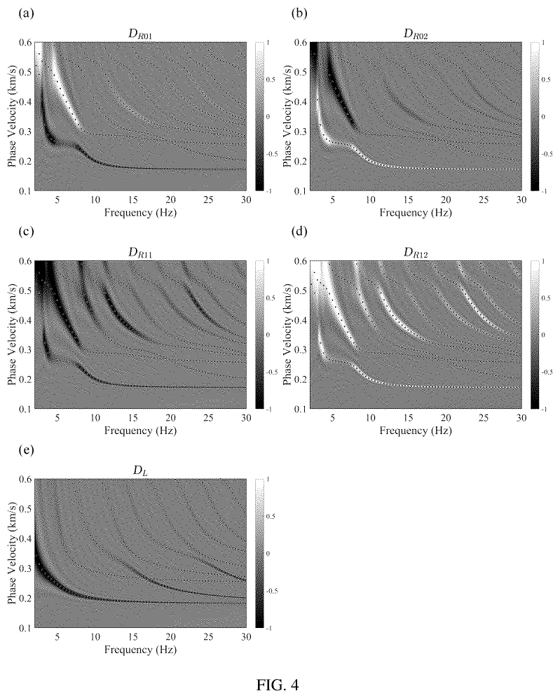

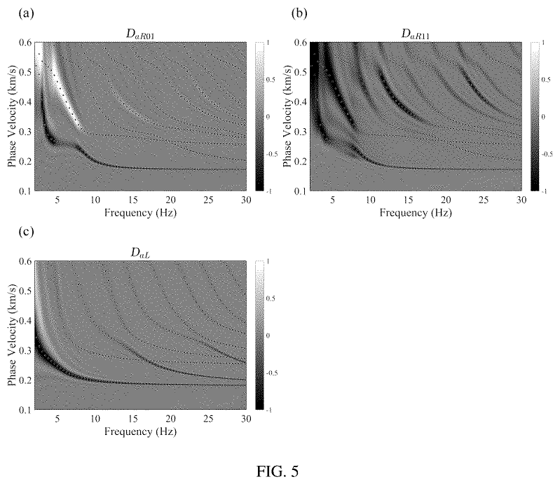

As shown in FIG. 4 and FIG. 5, show actual surface wave dispersion spectrum of the active source data with known source extracted by using the Frequency-Bessel transform and approximate Frequency-Bessel transform in one embodiment of the present disclosure. In each figure, the horizontal axis is the frequency and the vertical axis is the phase velocity. FIG. 4(a) is the actual dispersion spectrum D_{R01} of Rayleigh waves extracted from the Green's function components corresponding to the radial normal strain from vertical excitation and the tangential normal strain from vertical excitation calculated by formula (19). FIG. 4(b) is the actual dispersion spectrum D_{R02} of Rayleigh waves extracted from the Green's function components corresponding to the vertical normal strain from vertical excitation calculated by formula (20). FIG. 4(c) is the actual dispersion spectrum D_{R11} of Rayleigh waves extracted from the Green's function components corresponding to the radial normal strain from radial excitation and the tangential normal strain from radial excitation calculated by formula (21). FIG. 4(d) is the actual dispersion spectrum D_{R12} of Rayleigh waves extracted from the Green's function components corresponding to the vertical normal strain from radial excitation calculated by formula (22). FIG. 4(e) is the theoretical dispersion spectrum D of Love waves extracted from the Green's function components corresponding to the radial shear strain from tangential excitation and the tangential normal strain from radial excitation calculated by formula (23). FIG. 5(a) is the theoretical dispersion spectrum D_{aR01} of Rayleigh waves extracted from the Green's function components corresponding to the radial normal strain from the vertical excitation calculated by formula (24). FIG. 5(b) is the actual dispersion spectrum D_{aR11} of Rayleigh waves extracted from the Green's function components corresponding to the radial normal strain excited radially calculated by formula (25). FIG. 5(c) is the Love wave dispersion spectrum result Dal extracted from the Green's function component corresponding to the radial normal strain from radial excitation calculated by formula (26).

The present disclosure provides a method for extracting surface wave dispersion curves based on a strain field, further including: S5, picking surface wave dispersion curves according to the surface wave dispersion spectrum.

Specifically, the step S5 includes:
S51, identifying dispersion energy of the strain components from actual dispersion spectrum;
S52, determining a frequency and a corresponding phase velocity value of the surface wave based on a position of an extreme value in the dispersion energy in the Frequency-Phase Velocity Domain;
S53, picking the surface wave dispersion curves of the strain components based on a plurality of sets of the frequencies and the corresponding phase velocity values of the surface wave.

Specifically, in the step S52, the position in the Frequency-Phase Velocity Domain refers to the position in the coordinate axis where the horizontal axis is the frequency and the vertical axis is the phase velocity.

Specifically, since the Frequency-Phase Velocity Domain can be equivalently replaced by the Frequency-Wavenumber domain, the step S52 can also be replaced by: determining a frequency and a corresponding phase velocity value of the surface wave based on a position of an extreme value in the dispersion energy in Frequency-Wavenumber Domain. The step S53 can also be replaced by: picking the surface wave dispersion curves of the strain components based on a plurality of sets of the frequencies and the corresponding wavenumber values of the surface wave.

Specifically, in the step S52, the position in the Frequency-Wavenumber Domain refers to the position in the coordinate axis where the horizontal axis is the frequency and the vertical axis is the wavenumber.

In each surface wave dispersion spectrum of FIG. 3, FIG. 4, and FIG. 5, the strip-shaped colored parts represent the distribution of the surface wave dispersion curves, which reflect the distribution of the surface wave dispersion energy.

Specifically, after the step S5, the method further includes: verifying an accuracy of the actual dispersion spectrum and the surface wave dispersion curves by double verification.

The theoretical dispersion spectrum is configured to verify the accuracy of the actual dispersion spectrum. As shown in FIG. 3, it is the theoretical surface wave dispersion spectrum in one embodiment forward modeling calculated by the Generalized Reflection-Transmission Coefficient Method. As shown in FIG. 4, it is the plurality of actual surface wave dispersion spectrum extracted from the corresponding Green's function components of the strain fields by the Frequency-Bessel transform method in one embodiment of the present disclosure for active source data with known sources. As shown in FIG. 5, it is an actual surface wave dispersion spectrum extracted from the corresponding Green's function components of the strain fields by the approximate Frequency-Bessel transform method in one embodiment of the present disclosure for active source data with known sources. The curve composed of black solid points in FIG. 4 and FIG. 5 is the actual surface wave dispersion spectrum calculated by the forward scheme of the prior art. In the each surface wave dispersion spectrum of FIG. 3, FIG. 4, and FIG. 5, the strip-shaped colored parts represent the distribution of the surface wave dispersion curves, which reflect the distribution of the surface wave dispersion energy. Based on the same strain data, FIG. 3(a) to FIG. 3(c) corresponds to FIG. 4(a) to FIG. 4(e) one by one. Based on the same strain data, FIG. 5(a) to FIG. 5(c) corresponds to FIG. 3(a), FIG. 3(c), FIG. 3(e) one by one. It can be seen from FIG. 3, FIG. 4, and FIG. 5 that the actual surface wave dispersion spectrum obtained by the method in the present disclosure is highly consistent with the theoretical surface wave dispersion spectrum, and can be well matched with the theoretical surface wave dispersion spectrum of the prior art. The actual surface wave dispersion spectrum of the present disclosure has been double-verified with the theoretical surface wave dispersion spectrum and the theoretical surface wave dispersion spectrum of the prior art, verifying the effectiveness and accuracy of the Frequency-Bessel transform method and the approximate Frequency-Bessel transform method of the present disclosure.

In addition to the above active source data for known source, the present disclosure can also use different Frequency-Bessel transform formulas for passive source data (such as background noise data) and active source data of unknown source to extract surface wave dispersion spectrum and then pick surface wave dispersion curves. The step of picking surface wave dispersion curves from the surface wave dispersion spectrum is the same as the processing process of active source data with a known source, specifically referring to the step S5.

Specifically, for the strain data extracted from the passive source data, it is necessary to convert the strain data into empirical Green's function components, and use the empirical Green's function components as strain components to obtain the surface wave dispersion spectrum by Fourier transform and Frequency-Bessel transform.

The passive source data usually refers to background noise observation data, which can be restored by the empirical Green's function (also called noise cross-correlation function).

Specifically, based on the relationship between the Green's function and the empirical Green's function, that is, the empirical Green's function C is proportional to the imaginary part of the Green's function G (i.e., C_{ξ,ζ}=A·Im(G_{ξ,ζ})), by modifying formulas (19) to (26), the Frequency-Bessel transform formulas for extracting the surface wave dispersion curves from passive source data are obtained as follows:

$${I}_{R 01} ( k , z , ω ) = Re ( {\int }_{{r}_{min}}^{{r}_{max}} [ {C}_{r r , Z} ( r , z , ω ) + {C}_{θ θ , Z} ( r , z , ω ) ] {J}_{0} ( k r ) rdr ) , \qquad ( 27 )$$

$${I}_{R 02} ( k , z , ω ) = Re ( {\int }_{{r}_{min}}^{{r}_{max}} {C}_{z z , Z} ( r , z , ω ) {J}_{0} ( k r ) r dr ) , \qquad ( 28 )$$

$${I}_{R 11} ( k , z , ω ) = Re ( {\int }_{{r}_{min}}^{{r}_{max}} [ {C}_{r r , R} ( r , z , ω ) + {C}_{θ θ , R} ( r , z , ω ) ] {J}_{1} ( k r ) r dr ) , \qquad ( 29 )$$

$${I}_{R 12} ( k , z , ω ) = Re ( {\int }_{{r}_{min}}^{{r}_{max}} {C}_{z z , R} ( r , z , ω ) {J}_{1} ( k r ) r dr ) , \qquad ( 30 )$$

$${I}_{L} ( k , z , ω ) = Re ( {\int }_{{r}_{min}}^{{r}_{max}} [ {C}_{r θ , T} ( r , z , ω ) - {C}_{θ θ , R} ( r , z , ω ) ] {J}_{1} ( k r ) r dr ) , \qquad ( 31 )$$

$${I}_{aR 01} ( k , z , ω ) = Re ( {\int }_{{r}_{min}}^{{r}_{max}} {C}_{rr , Z} ( r , z , ω ) {J}_{0} ( k r ) r dr ) , \qquad ( 32 )$$

$${I}_{aR 11} ( k , z , ω ) = Re ( {\int }_{{r}_{min}}^{{r}_{max}} {C}_{r r , R} ( r , z , ω ) {J}_{1} ( k r ) r dr ) , \qquad ( 33 )$$

$${I}_{aL} ( k , z , ω ) = Re ( {\int }_{{r}_{min}}^{{r}_{max}} {C}_{r θ , T} ( r , z , ω ) {J}_{1} ( k r ) r dr ) , \qquad ( 34 )$$

The operation Re(⋅) represents taking a real part of a complex number.

For the active source data with unknown seismic sources, that is, the active source data with a single force point source, the strain data can be directly used as the strain components, and the surface wave dispersion spectrum can be obtained through Fourier transform and Frequency-Bessel transform. Therefore, the above formulas (19) to (26) are modified to obtain the Frequency-Bessel transform formula for extracting the surface wave dispersion curves from the active source data with unknown sources:

$${E}_{R 01} ( k , z , ω ) = \vert {\int }_{{r}_{min}}^{{r}_{max}} [ {ε}_{r r , Z} ( r , z , ω ) + {ε}_{θ θ , Z} ( r , z , ω ) ] {J}_{0} ( k r ) rdr \vert , \qquad ( 35 )$$

$${E}_{R 02} ( k , z , ω ) = \vert {\int }_{{r}_{min}}^{{r}_{max}} {ε}_{z z , Z} ( r , z , ω ) {J}_{0} ( k r ) rdr \vert , \qquad ( 36 )$$

$${E}_{R 11} ( k , z , ω ) = \vert {\int }_{{r}_{min}}^{{r}_{max}} [ {ε}_{rr , R} ( r , z , ω ) + {ε}_{θ θ , R} ( r , z , ω ) ] {J}_{1} ( k r ) rdr \vert , \qquad ( 37 )$$

$${E}_{R 12} ( k , z , ω ) = \vert {\int }_{{r}_{min}}^{{r}_{max}} {ε}_{zz , R} ( r , z , ω ) {J}_{1} ( k r ) rdr \vert , \qquad ( 38 )$$

$${E}_{L} ( k , z , ω ) = \vert {\int }_{{r}_{min}}^{{r}_{max}} [ {ε}_{r θ , T} ( r , z , ω ) - {ε}_{θθ , R} ( r , z , ω ) ] {J}_{1} ( k r ) rdr \vert , \qquad ( 39 )$$

$${E}_{aR 01} ( k , z , ω ) = \vert {\int }_{{r}_{min}}^{{r}_{max}} {ε}_{r r , Z} ( r , z , ω ) {J}_{0} ( k r ) rdr \vert , \qquad ( 40 )$$

$${E}_{aR 11} ( k , z , ω ) = \vert {\int }_{{r}_{min}}^{{r}_{max}} {ε}_{r r , R} ( r , z , ω ) {J}_{1} ( k r ) rdr \vert , \qquad ( 41 )$$

$${E}_{aL} ( k , z , ω ) = \vert {\int }_{{r}_{min}}^{{r}_{max}} {ε}_{r θ , T} ( r , z , ω ) {J}_{1} ( k r ) rdr \vert , \qquad ( 42 )$$

The operation |⋅| represents taking the absolute value of a real number or the modulus of a complex number.

Specifically, for passive source data (such as background noise data) and active source data with unknown sources, the actual dispersion spectrum is obtained by Fourier transform and Frequency-Bessel transform. The specific process is the same as the above steps for active source data with known sources.

In summary, the present disclosure can process different types of multi-component DAS data, including active source data with known seismic sources, active source data with unknown seismic sources, and passive source data, and has wider practicality.

Preferably, the surface wave dispersion curves include Rayleigh wave dispersion curves and Love wave dispersion curves.

Preferably, the first-kind Bessel function Jᵥ(kr) in the Frequency-Bessel transform formula can be replaced by the third-kind Bessel function

$${H}_{v}^{( 2 )} ( k r )$$

(i.e., Hankel function), which can effectively avoid possible spatial aliasing.

Preferably, the method of extracting surface wave dispersion curves based on strain fields of the present disclosure can also be applied to strain rate field data after being converted into strain field data.

Preferably, since the Scholte waves propagating along the seafloor surface are similar to the Rayleigh waves propagating on the land surface in theory and application, the Frequency-Bessel transform formula applicable to Rayleigh waves is also applicable to extracting Scholte wave dispersion information. Preferably, the method for extracting surface wave dispersion curves provided in the present disclosure can also be applied to extracting body wave dispersion curves.

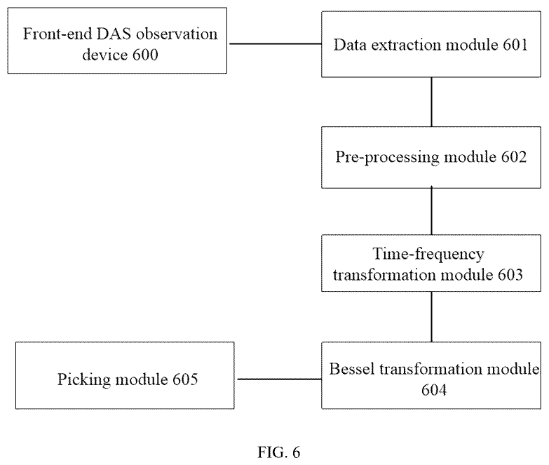

The second aspect of the present disclosure is to provide a system for extracting surface wave dispersion curves based on strain fields. As shown in FIG. 6, it is a schematic diagram of a system for extracting surface wave dispersion curves based on strain fields of the present disclosure. The system includes:
A data extraction module 601, configured to extract strain data from seismic observation data;
A pre-processing module 602, configured to pre-process the strain data according to types of the seismic observation data to obtain strain components;
A time-frequency transformation module 603, configured to transform the strain components from Temporal-Spatial Domain to Spatial-Frequency Domain by Fourier Transform;
A Bessel transformation module 604, configured to transform the strain components from the Spatial-Frequency Domain to Frequency-Phase Velocity Domain through Frequency-Bessel Transform to obtain the surface wave dispersion spectrum of the strain component;
A picking module 605, configured to pick surface wave dispersion curves according to the surface wave dispersion spectrum.

Specifically, the Bessel transformation module 604 may also be configured to transform the strain components from the Spatial-Frequency Domain to the Frequency-Wavenumber domain through Frequency-Bessel Transformation to obtain the surface wave dispersion spectrum of the strain components;

The system also includes a front-end DAS observation device 600, which mainly consists of two parts: a demodulator, including an optical system and a signal acquisition system; and an optical fiber for sensing. The optical fiber in the DAS observation device is arranged horizontally, vertically, or spirally, etc., and is configured to obtain single-component or multi-component DAS data and send the single-component or the multi-component to the data extraction module.

The third aspect of the present disclosure is to provide a terminal, including: a memory, a processor, and a program for a method for extracting surface wave dispersion curves based on strain fields stored in the memory and executable on the processor, where the program of a method for extracting surface wave dispersion curves based on strain fields implements the steps of a method for extracting surface wave dispersion curves based on strain fields when executed by the processor.

The fourth aspect of the present disclosure is to provide a computer-readable storage medium, which stores a program for a method for extracting surface wave dispersion curves based on strain fields. When the program of the method for extracting surface wave dispersion curves based on strain fields is executed by a processor, the steps of a method for extracting surface wave dispersion curves based on strain fields are implemented.

In summary, the present disclosure provides a method for extracting surface wave dispersion curves based on strain fields, including: extracting strain data from seismic observation data; pre-processing the strain data according to types of the seismic observation data to obtain strain components; transforming the strain components from Temporal-Spatial Domain to Spatial-Frequency Domain by Fourier Transform; transforming the strain components from the Spatial-Frequency Domain to Frequency-Phase Velocity Domain by Frequency-Bessel Transform to obtain a surface wave dispersion spectrum of the strain components; picking surface wave dispersion curves according to the surface wave dispersion spectrum. For single-component or multi-component DAS data and from the perspective of strain fields, the present disclosure proposes different Frequency-Bessel transform formulas for active source data with known seismic sources, active source data with unknown seismic sources, and passive source data, respectively, to extract surface wave dispersion spectrum, and then pick surface wave dispersion curves, filling the technical gap in extracting surface wave dispersion information from DAS data, and providing a powerful tool for extracting surface wave dispersion information suitable for single-component or multi-component DAS data. It has important theoretical significance and practical value for the development of surface wave dispersion imaging methods based on DAS observations, and provides ideas for extracting dispersion information of surface waves or body waves such as Rayleigh waves, Scholte waves, and Love waves.

The above description is only preferred embodiments of the present disclosure and is not intended to limit the present disclosure. Any modifications, equivalent substitutions, improvements, etc. made within the spirit and principles of the present disclosure should be included in the protection scope of the present disclosure.

What is claimed is:

1. A method for extracting surface wave dispersion curves based on strain fields, comprising:
extracting strain data from seismic observation data;
pre-processing the strain data according to types of the seismic observation data to obtain strain components;
transforming the strain components from Temporal-Spatial Domain to Spatial-Frequency Domain by Fourier Transform;
transforming the strain components from the Spatial-Frequency Domain to Frequency-Phase Velocity Domain by Frequency-Bessel Transform to obtain a surface wave dispersion spectrum of the strain components; and
picking surface wave dispersion curves according to the surface wave dispersion spectrum.

2. The method for extracting surface wave dispersion curves based on strain fields according to claim 1, wherein the seismic observation data is single-component or multi-component DAS strain observation data; and the types of the seismic observation data comprise one or more of active source data with known sources, active source data with unknown sources, and passive source data.

3. The method for extracting surface wave dispersion curves based on strain fields according to claim 2, wherein pre-processing the strain data according to types of the seismic observation data to obtain strain components comprises:
for the strain data extracted from the active source data with known sources, transforming the strain data into Green's function components by deconvolution processing, wherein the strain components are the Green's function components;
for the strain data extracted from the active source data with unknown sources, directly using the strain data extracted from the active source data with unknown source as the strain components; and
for the strain data extracted from the passive source data, transforming the strain data into empirical Green's function components, and the strain components are the empirical Green's function components.

4. The method for extracting surface wave dispersion curves based on strain fields according to claim 3, wherein transforming the strain data into empirical Green's function components comprises:
performing background noise processing on the strain data to restore the empirical Green's function components;
wherein the background noise processing comprises single-channel pre-processing, two-channel cross-correlation processing, and superposition processing of noise cross-correlation functions in different time periods; and
wherein the single-channel pre-processing comprises: removing instrument response processing, data segmentation processing, removing mean processing, detrending processing, bandpass filtering processing, time domain normalization processing, and spectrum whitening processing.

5. The method for extracting surface wave dispersion curves based on strain fields as described in claim 1, wherein the strain data includes one or more of radial normal strain, radial shear strain, tangential normal strain, and vertical normal strain.

6. The method for extracting surface wave dispersion curves based on strain fields according to claim 5, wherein after the extracting strain data from seismic observation data, the method further comprises:
synthesizing strain field records based on multiple channels of the strain data;
wherein the strain field records comprise radial normal strain records from vertical excitation, vertical normal strain records from vertical excitation, tangential normal strain records from vertical excitation, radial normal strain records from radial excitation, vertical normal strain records from radial excitation, tangential normal strain records from radial excitation, and radial shear strain records from tangential excitation.

7. The method for extracting surface wave dispersion curves based on strain fields according to claim 1, wherein picking surface wave dispersion curves according to the surface wave dispersion spectrum comprises:
identifying dispersion energy of the strain components from actual dispersion spectrum;
determining a frequency and a corresponding phase velocity value of the surface wave based on a position of an extreme value in the dispersion energy in the Frequency-Phase Velocity Domain; and
picking the surface wave dispersion curves of the strain components based on a plurality of sets of the frequencies and the corresponding phase velocity values.

8. The method for extracting surface wave dispersion curves based on strain fields according to claim 7, wherein the surface wave dispersion curves comprise Rayleigh wave dispersion curves and Love wave dispersion curves.

9. A system for extracting surface wave dispersion curves based on strain fields, the system comprising:
a data extraction module configured to extract strain data from seismic observation data;
a pre-processing module configured to pre-process the strain data according to types of the seismic observation data to obtain strain components;
a time-frequency transformation module configured to transform the strain components from Temporal-Spatial Domain to Spatial-Frequency Domain by Fourier Transform;
a Bessel transformation module configured to transform the strain components from the Spatial-Frequency Domain to Frequency-Phase Velocity Domain by Frequency-Bessel Transform to obtain the surface wave dispersion spectrum of the strain component; and
a picking module configured to pick surface wave dispersion curves according to the surface wave dispersion spectrum.

10. A terminal, comprising: a memory, a processor, and a program for extracting surface wave dispersion curves based on strain fields stored in the memory and executed by the processor, wherein, when the program is executed by the processor, steps of the method for extracting surface wave dispersion curves based on strain fields according to claim 1 are implemented.
